(19) United States
(12) Patent Application Publication
(10) Pub. No.: US 2025/0294290 A1
(43) Pub. Date: Sep. 18, 2025

(54) ELECTRONIC DEVICE

(71) Applicant: Panasonic Intellectual Property Management Co., Ltd., Osaka (JP)

(72) Inventors: Kenji MAEDA, Osaka (JP); Masashi FUJIMOTO, Osaka (JP); Tetsunobu YUI, Osaka (JP)

(21) Appl. No.: 19/074,922

(22) Filed: Mar. 10, 2025

(30) Foreign Application Priority Data
Mar. 18, 2024 (JP) 2024-042233

(51) Int. Cl. H04R 3/04

(52) U.S. Cl. CPC H04R 3/04; H04R 2420/09; H04R 2499/13

(57) ABSTRACT

An electronic device is an electronic device to be provided inside a moving object, and includes: a first housing that accommodates a converter that converts an audio signal from a digital signal to an analog signal; and a second housing provided with a jack that outputs the audio signal that has been converted to the analog signal, where the second housing is different from the first housing. The first housing is connected to the second housing via a first cable.

### CROSS REFERENCE TO RELATED APPLICATION(S)

The present application is based on and claims priority of Japanese Patent Application No. 2024-042233 filed on Mar. 18, 2024. The entire disclosure of the above-identified application, including the specification, drawings and claims is incorporated herein by reference in its entirety.

### FIELD

The present invention relates to an electronic device provided inside a moving object.

### BACKGROUND

Patent Literature (PTL) 1 discloses an electronic device including a converter that converts a digital audio signal to an analog audio signal, and a terminal that outputs an analog audio signal.

### CITATION LIST

### Patent Literature

PTL 1: Japanese Unexamined Patent Application Publication No. 2009-16892

### SUMMARY

### Technical Problem

With the electronic device disclosed in PTL 1, however, since a converter that converts a digital audio signal to an analog audio signal and a terminal that outputs an analog audio signal are provided in a single housing, there is a problem that the size of the housing increases.

In view of this, the present disclosure provides an electronic device that can inhibit an increase in the size of a housing provided with a jack that outputs an audio signal.

### Solution to Problem

An electronic device according to one aspect of the present disclosure is an electronic device to be provided inside a moving object, and includes: a first housing that accommodates a converter that converts an audio signal from a digital signal to an analog signal; and a second housing provided with a jack that outputs the audio signal that has been converted to the analog signal, where the second housing is different from the first housing. The first housing is connected to the second housing via a first cable.

### Advantageous Effects

The electronic device according to the present disclosure can inhibit an increase in the size of a housing provided with a jack that outputs an audio signal.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an electronic device and others according to an embodiment.

FIG. 2 is a schematic diagram illustrating a first housing and others of the electronic device illustrated in FIG. 1.

FIG. 3 is a schematic diagram illustrating a second housing and others of the electronic device illustrated in FIG. 1.

FIG. 4 is a schematic diagram illustrating a second housing and others according to another model.

FIG. 5 is a schematic diagram illustrating a second housing and others according to yet another model.

FIG. 6 is a schematic diagram illustrating a second housing and others according to yet another model.

FIG. 7 is a block diagram illustrating the functional configuration of the electronic device illustrated in FIG. 1.

FIG. 8 is a schematic diagram illustrating an electronic device and others according to other embodiment.

### DESCRIPTION OF EMBODIMENT

An electronic device according to one aspect of the present disclosure is an electronic device to be provided inside a moving object, and includes: a first housing that accommodates a converter that converts an audio signal from a digital signal to an analog signal; and a second housing provided with a jack that outputs the audio signal that has been converted to the analog signal, where the second housing is different from the first housing. The first housing is connected to the second housing via a first cable.

According to this, since the second housing provided with the jack that outputs an audio signal is different from the first housing that accommodates the converter, it is possible to inhibit an increase in the size of the second housing compared to when the second housing accommodates the converter.

In the electronic device according to one aspect of the present disclosure, the first housing may be provided at a first location that a user of the electronic device cannot directly touch, and the jack may be provided at a second location that the user can directly touch.

According to this, it is possible to inhibit an increase in the size of the jack at a location that the user can directly touch.

In the electronic device according to one aspect of the present disclosure, the first location may include the inside of a first seat on which the user sits, the inside of a second seat near the first seat, or the inside of a structure in the vicinity of the first seat. The second location may include a location exposed to outside on the first seat, a location exposed to outside on the second seat, or a location exposed to outside on the structure.

According to this, it is possible to inhibit an increase in the size of the jack exposed in the vicinity of the seat of the user.

The electronic device according to one aspect of the present disclosure may further include a third housing that accommodates a processor that decompresses the audio signal that has been compressed, where the third housing is different from the first housing and the second housing. The first housing may be connected to the third housing via a second cable.

According to this, since the third housing that accommodates the processor is different from the first housing and the second housing, it is possible to inhibit an increase in the size of the first housing or the second housing compared to when the first housing or the second housing accommodates the processor.

In the electronic device according to one aspect of the present disclosure, the total number of cores of the second cable may be less than the total number of cores of the first cable.

According to this, it is easier to reduce the weight of the entire electronic device.

In the electronic device according to one aspect of the present disclosure, a first connector to which the first cable is to be connected and a second connector to which the second cable is to be connected may be provided in the first housing, and the first connector and the second connector may have different shapes.

According to this, it is easier to use a suitable cable for each of the first cable and the second cable.

In the electronic device according to one aspect of the present disclosure, the first connector and the second connector may face away from each other, and the first housing may be formed such that the connection direction of the first cable toward the first connector is the lengthwise direction of the first housing.

According to this, it is possible to inhibit an increase in the size of the first housing in a direction orthogonal to the connection direction of the first cable toward the first connector.

In the electronic device according to one aspect of the present disclosure, the first housing may be provided to obtain, via the second cable, necessity information related to necessity of power supply to the jack, determine the necessity based on the necessity information, and supply power via the first cable when it is determined that the power supply is necessary.

According to this, power can be supplied to the jack when power supply to the jack is necessary.

In the electronic device according to one aspect of the present disclosure, the second housing may be configurable in a plurality of models, each including the jack of a different shape, where each of the jacks is the jack.

According to this, it is possible to output an audios signal to a plurality of devices having plugs whose shapes are mutually different.

In the electronic device according to one aspect of the present disclosure, the jacks may include a jack compliant with an ARINC standard.

According to this, it is possible to output an audio signal to a device having a plug compliant with the ARINC standard.

Hereinafter, embodiments of the present disclosure will be described in detail with reference to the drawings.

The embodiment described below illustrates a general or specific example of the present disclosure. The numerical values, shapes, materials, elements, the arrangement and connection of the elements, steps, and orders of steps etc., shown in the following embodiment are mere examples, and therefore are not intended to limit the scope of the present disclosure. Among the elements in the following embodiment, those not recited in any of the independent claims are described as optional elements. The figures are schematic diagrams and are not necessarily precise illustrations. Elements that are essentially the same share the same reference signs in the figures.

### EMBODIMENT

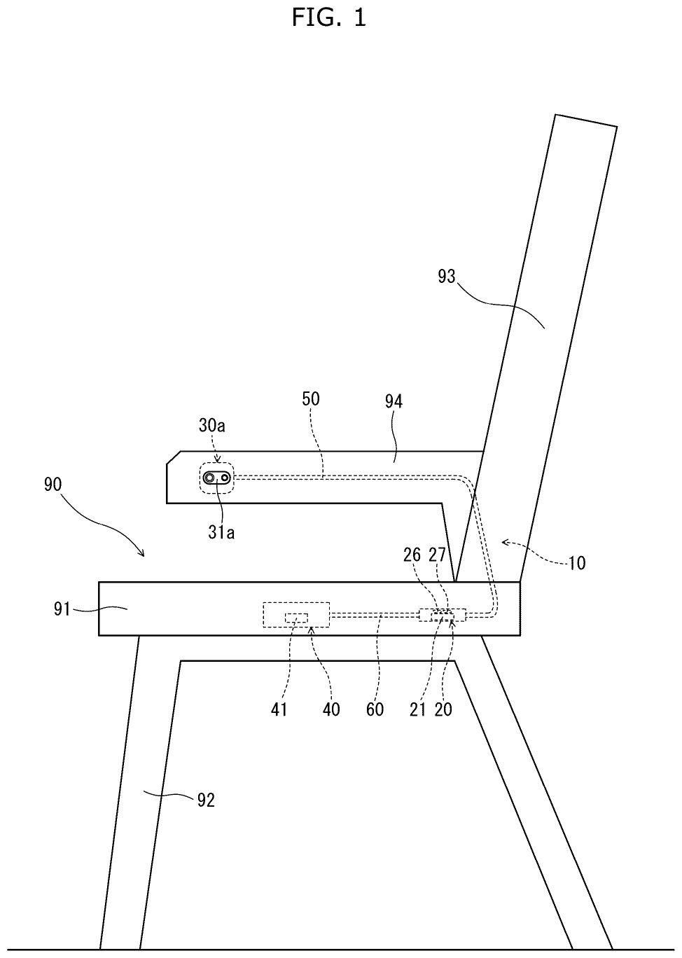

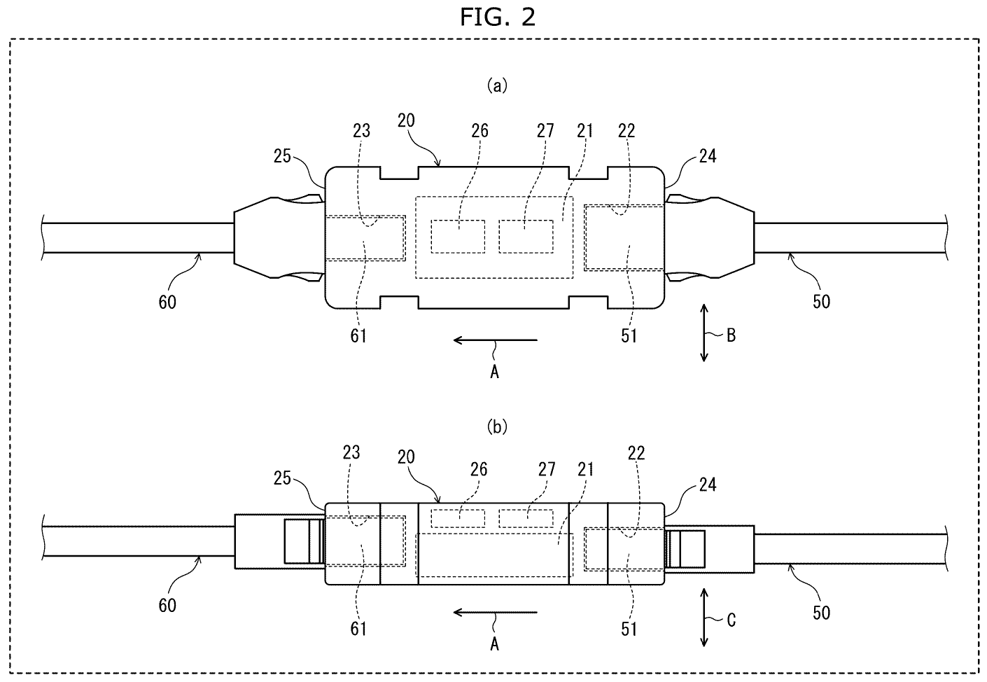

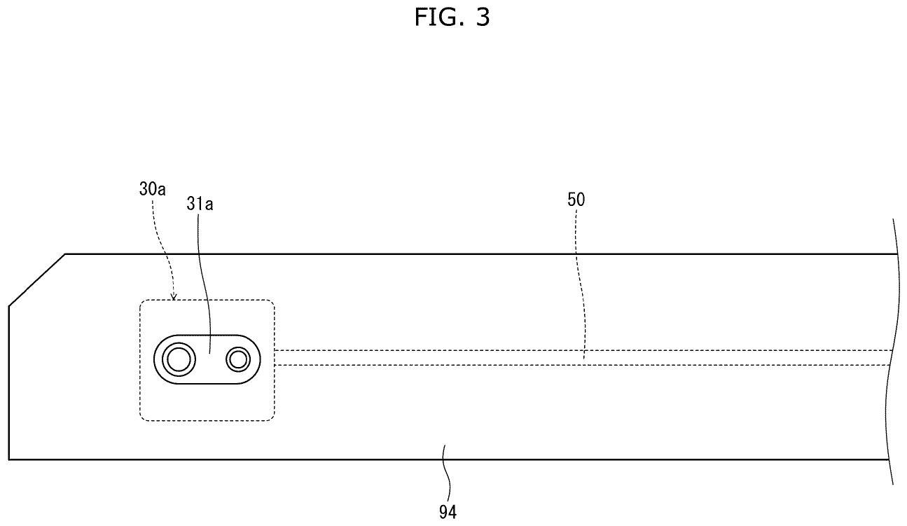

FIG. 1 is a schematic diagram illustrating electronic device 10 and others according to an embodiment. FIG. 2 is a schematic diagram illustrating first housing 20 and others of electronic device 10 illustrated in FIG. 1. (a) in FIG. 2 shows a state in which, for instance, first housing 20 is viewed along one direction, and (b) in FIG. 2 shows a state in which, for instance, first housing 20 is viewed from a direction orthogonal to that one direction. FIG. 3 is a schematic diagram illustrating, for instance, second housing 30a of electronic device 10 illustrated in FIG. 1. The configuration of electronic device 10 and others will be described with reference to FIG. 1 to FIG. 3.

Electronic device 10 is provided inside a moving object and converts an audio signal from a digital signal to an analog signal to output the audio signal. A moving object is, for example, a transport capable of transporting a person on board, and is, for instance, a vehicle, an aircraft, or a vessel. A vehicle is, for instance, a car or a railroad car. In the present embodiment, electronic device 10 is provided on seat 90 in a moving object, as illustrated in FIG. 1.

Seat 90 is a seat for the user of electronic device 10 to sit on. The user of electronic device 10 is, for instance, a passenger in a moving object. Hereinafter, the user of electronic device 10 may be simply referred to as “user”. Seat 90 includes seat portion 91 for the user to sit on, leg portion 92 that supports seat portion 91, backrest portion 93 for supporting the user on seat portion 91 from back, and armrest portion (armrest) 94 for the user sitting on seat portion 91 to place, for instance, their elbow. The user can use electronic device 10 while seated on seat portion 91.

Electronic device 10 includes first housing 20, second housing 30a, third housing 40, first cable 50, and second cable 60.

First housing 20 accommodates converter 21, supplier 26, and amplifier 27. First housing 20 is provided at a first location that the user cannot directly touch. Accordingly, the user as a passenger in a moving object cannot directly touch first housing 20 when using electronic device 10 in a passenger's operation such as the playback of music which is normally assumed to be performed by a passenger. In the present embodiment, the first location is the inside of seat 90. Specifically, the first location is the inside of seat portion 91. When the user sits on seat portion 91 and uses electronic device 10, the user cannot directly touch first housing 20 since first housing 20 is provided inside seat portion 91. Note that the inside of seat 90 is not limited to the inside of seat portion 91 and includes the inside of a housing provided below seat portion 91. The first location may be, for instance, the inside of armrest portion 94.

As illustrated in FIG. 2, first housing 20 is provided with first connector 22 and second connector 23. First housing 20 is formed so that the connection direction of first cable 50 toward first connector 22 (see arrow A in FIG. 2) is the lengthwise direction of first housing 20. In addition, first housing 20 is formed so that a direction orthogonal to the lengthwise direction of first housing 20 is the crosswise direction of first housing 20 (see arrow B in (a) in FIG. 2) and that a direction orthogonal to the lengthwise direction and the cross wise direction of first housing 20 is the thickness direction of first housing 20 (see arrow C in (b) in FIG. 2). The length of first housing 20 in the lengthwise direction is greater than the length of first housing 20 in the crosswise direction and the length of first housing 20 in the thickness direction. Hereinafter, the connection direction of first cable 50 toward first connector 22 may be simply referred to as “connection direction”.

First connector 22 is a connector to which first cable 50 is to be connected. First connector 22 is a female connector, and connector 51 of first cable 50, which is a male connector, is inserted into first connector 22 in the connection direction of first cable 50. First connector 22 is provided at end face 24 on one side of first housing 20 in the lengthwise direction of first housing 20.

Second connector 23 is a connector to which second cable 60 is to be connected. Second connector 23 faces away from first connector 22. Second connector 23 is a female connector, and connector 61 of second cable 60, which is a male connector, is inserted into second connector 23 in a direction opposite the connection direction of second cable 60. Second connector 23 is provided at end face 25 on the other side of first housing 20 in the lengthwise direction of first housing 20.

First connector (terminal) 22 and second connector (terminal) 23 have different shapes. For example, first connector 22 has a shape compliant with a given standard and second connector 23 has a shape compliant with a standard different from the given standard. Since the standard with which first connector 22 is compliant is thus different from the standard with which second connector 23 is compliant, the shape of first connector 22 is different from the shape of second connector 23. Note that these shapes are not specifically limited and may be compliant with a standard to be used.

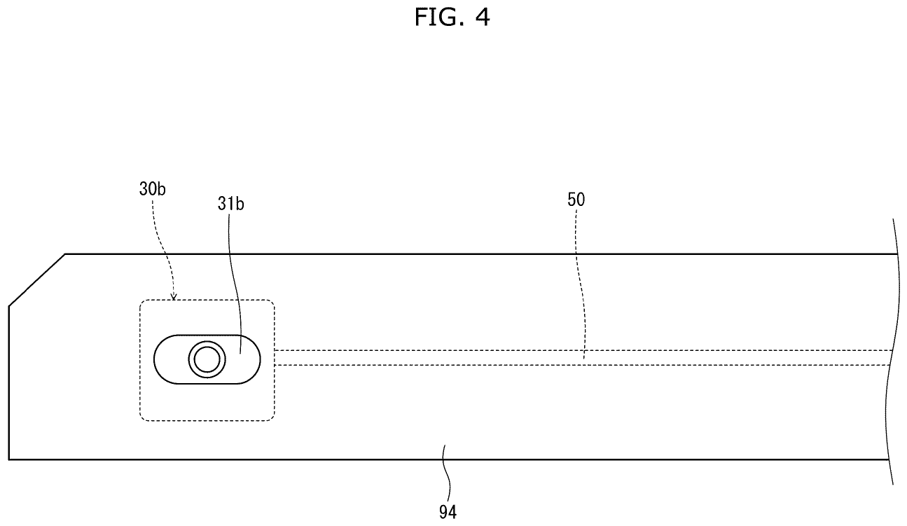

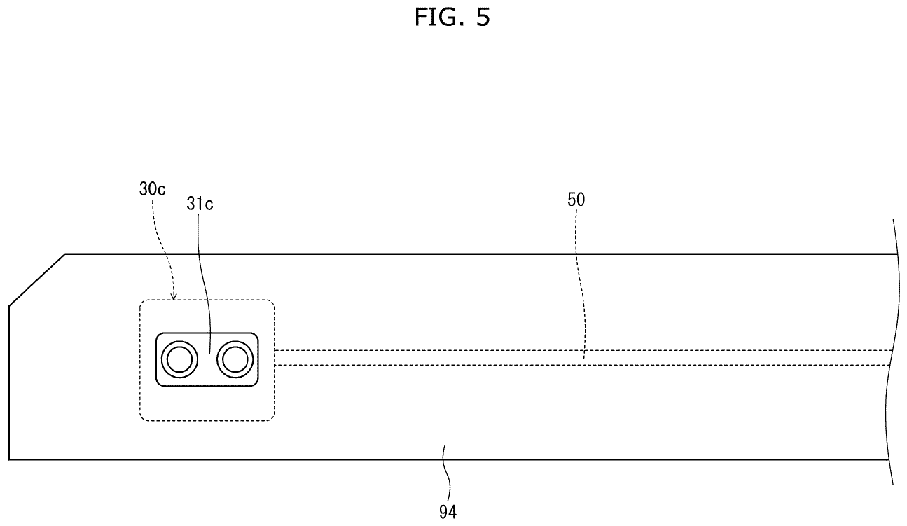

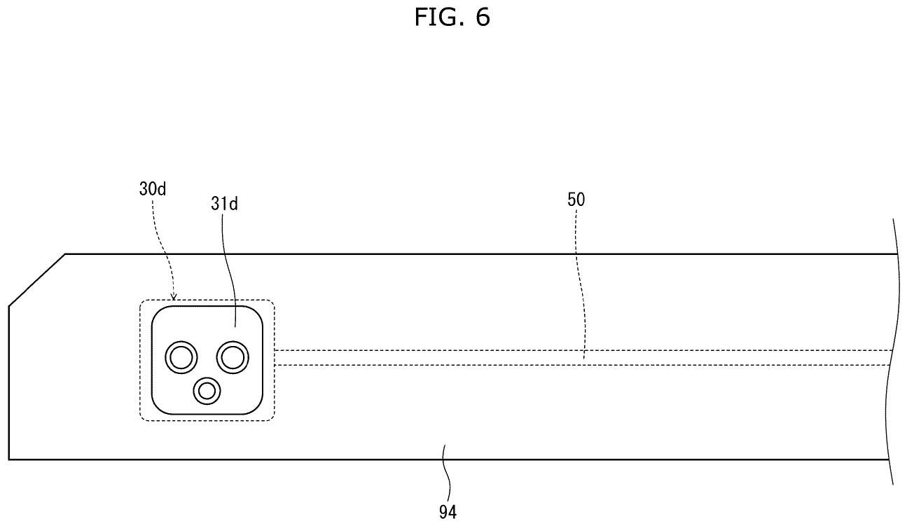

As illustrated in FIG. 1 and FIG. 3, second housing 30a is provided with jack 31a. Note that the second housing may be configurable in a plurality of models. Besides second housing 30a, the plurality of models may include, for example, second housing 30b as illustrated in FIG. 4, second housing 30c as illustrated in FIG. 5, and second housing 30d as illustrated in FIG. 6. In FIG. 1 and FIG. 3, second housing 30a is connected to first cable 50, but instead of second housing 30a, second housing 30b may be connected to first cable 50, as illustrated in FIG. 4, second housing 30c may be connected to first cable 50, as illustrated in FIG. 5, and second housing 30d may be connected to first cable 50, as illustrated in FIG. 6.

As illustrated in FIG. 4, second housing 30b is provided with jack 31b. As illustrated in FIG. 5, second housing 30c is provided with jack 31c. As illustrated in FIG. 6, second housing 30d is provided with jack 31d. Each of jacks 31a, 31b, 31c, and 31d is an audio jack that outputs an audio signal that has been converted to an analog signal. When each of jacks 31a, 31b, 31c, and 31d receives an audio signal via first cable 50 in a state in which a plug is inserted into the jack, the jack outputs the audio signal to a device having the plug. With this, sound in accordance with the audio signal can be output from the device, and with the use of the device, the user can listen to the sound in accordance with the audio signal. The device is, for example, earphones or headphones.

Jacks 31a, 31b, 31c, and 31d are of mutually different types (models) and have mutually different shapes. For example, a jack that fits the shape of the plug of a device (e.g., earphones) to be used may be selected from among jacks 31a, 31b, 31c, and 31d, and the second housing of the jack can be connected to first cable 50 for use.

Jacks 31a, 31b, 31c, and 31d include a jack compliant with the ARINC standard. In this case, jacks 31b, 31c, and 31d are compliant with the ARINC standard.

For example, jack 31b is an audio jack compliant with the ARINC 628 standard. The ARINC 628 is a standard related to the interface of room equipment in an aircraft. Audio jacks of a plurality of types are defined in the ARINC 628 standard, and the audio jacks include not only a jack with two holes like 31a, but also a jack with two holes having different shapes like 31c, a jack with one hole like 31b, and a jack with three holes like 31d. In other words, the second housing, like the above examples, is configurable in a plurality of models each including a jack of a different shape. Since each of second housings 30a, 30b, 30c, and 30d is configured to be attachable to and detachable from first cable 50 or first housing 20, the model of the second housing can be changed according to the shape of the plug of a device (e.g., earphones) that the user is assumed to use on seat 90.

Since the audio jacks compliant with the ARINC 628 standard include an audio jack that requires power supply from a device to which the audio jack is connected, depending on the type of the audio jack, supplier 26 to be described later determines whether power supply is necessary, and power, in addition to an audio signal from first housing 20, is supplied from first housing 20 to the audio jack that needs power supply. For example, there may be a case where power supply for the audio jack is necessary to activate the noise canceling of earphones connected to the audio jack.

Note that an audio jack to be provided in, for instance, second housing 30a is not limited to an audio jack compliant with the ARINC standard, and may be a general audio jack. In second housing 30a, a plurality of audio jacks may be provided in a single housing, or a universal serial bus (USB) or the like may be included.

Each of jacks 31a, 31b, 31c, and 31d is provided at a second location that the user can directly touch. Accordingly, the user can directly touch each of jacks 31a, 31b, 31c, and 31d when using electronic device 10. In the present embodiment, the second location is a location that is exposed to outside on seat 90. Specifically, the second location is a location that is exposed to outside on armrest portion 94. When the user sits on seat portion 91 and uses electronic device 10, the user can directly touch each of jacks 31a, 31b, 31c, and 31d since each of jacks 31a, 31b, 31c, and 31d is provided exposed to outside on armrest portion 94. Note that the second location may be, for instance, a location that is exposed to outside on seat portion 91, leg portion 92, or backrest portion 93. Each of second housings 30a, 30b, 30c, and 30d is provided inside armrest 94 so that the user cannot directly touch the second housing. Each of second housings 30a, 30b, 30c, and 30d is thus provided so as not to be exposed to outside while the jack provided in the second housing is exposed to outside.

Since second housings 30a, 30b, 30c, and 30d are configurable in a plurality of models in the present embodiment, a second housing to be connected to first cable 50 can be replaced according to, for instance, the shape of a jack. Note that since second housings 30a, 30b, 30c, and 30d are different from first housing 20, the second housing can be replaced without changing first housing 20, and first housing 20 can be commonly used among second housings 30a, 30b, 30c, and 30d.

As illustrated in FIG. 1, third housing 40 accommodates processor 41. Third housing 40 is provided at a third location that the user cannot directly touch. Accordingly, the user cannot directly touch third housing 40 when using electronic device 10. In the present embodiment, the third location is the inside of seat 90. Specifically, the third location is the inside of seat portion 91. When the user sits on seat portion 91 and uses electronic device 10, the user cannot directly touch third housing 40 since third housing 40 is provided inside seat portion 91. Note that the third location may be, for instance, the inside of armrest portion 94.

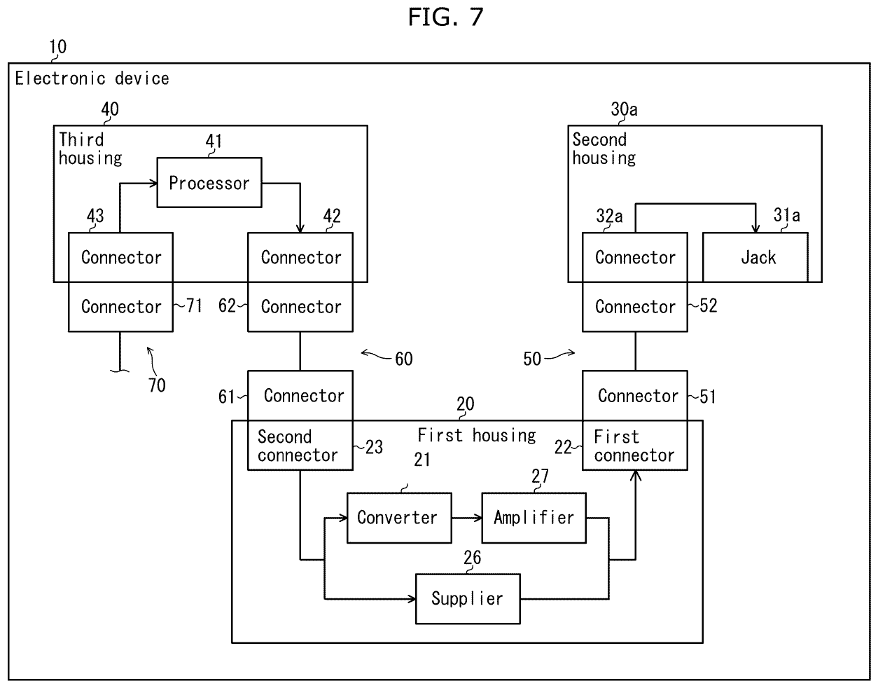

First cable 50 is connected to first housing 20 and second housing 30a, and first housing 20 is connected to second housing 30a via first cable 50. As described above, connector 51 is provided at one end portion of first cable 50 and connector 51 is connected to first connector 22. Connector 52 (see FIG. 7) having the same shape as connector 51 is provided at the other end portion of first cable 50, second housing 30 is provided with connector 32a (see FIG. 7) having the same shape as first connector 22, and connector 52 is connected to connector 32a. For example, the other end portion of first cable 50 may be fixed to second housing 30a. In this case, a male connector and a female connector may be provided between one end portion and the other end portion of first cable 50 so that first cable 50 can be disconnected or connected using the male connector and the female connector.

Second cable 60 is connected to first housing 20 and third housing 40, and first housing 20 is connected to third housing 40 via second cable 60. As described above, connector 61 is provided at one end portion of second cable 60, and connector 61 is connected to second connector 23. Connector 62 (see FIG. 7) having the same shape as connector 61 is provided at the other end of second cable 60, third housing 40 is provided with connector 42 (see FIG. 7) having the same shape as second connector 23, and connector 62 is connected to connector 42. For example, the other end portion of second cable 60 may be fixed to third housing 40. In this case, a male connector and a female connector may be provided between one end portion and the other end portion of second cable 60 so that second cable 60 can be disconnected or connected using the male connector and the female connector. The number of cores of second cable 60 is less than the number of cores of first cable 50. The number of cores is the number of core wires. By thus providing second cable 60 with cores that are less in number than the cores of first cable 50, it is possible to reduce the weight of a cable that connects third housing 40 and first housing 20. It is therefore easier to reduce the weight of the entire electronic device 10.

FIG. 4 is a block diagram illustrating the functional configuration of electronic device 10 illustrated in FIG. 1. The functional configuration of electronic device 10 will be described with reference to FIG. 4.

As illustrated in FIG. 4, electronic device 10 includes, for instance, converter 21, supplier 26, amplifier 27, jack 31a (31b, 31c, 31d), and processor 41.

Converter 21 converts an audio signal from a digital signal to an analog signal. Converter 21 is, for example, a D/A converter.

Supplier 26 obtains, via second cable 60, necessity information related to necessity of power supply to jack 31a (31b, 31c, 31d), determines the necessity based on the necessity information, and supplies power to jack 31a (31b, 31c, 31d) via first cable 50 when it is determined that power supply is necessary. The necessity information indicates whether power supply to jack 31a (31b, 31c, 31d) is necessary. The necessity information indicates whether power supply to the jack in the second housing connected to first cable 50 is necessary. When the necessity information indicates that the power supply is necessary, supplier 26 determines that the power supply is necessary. When the necessity information indicates that the power supply is not necessary, supplier 26 determines that the power supply is not necessary. For example, the necessity of power supply is set in advance by the manager of an audio system in a moving object, and necessity information indicating the details set by the manager is transmitted from, for instance, an external device to electronic device 10. Power that supplier 26 supplies is obtained from, for instance, batteries placed in a moving object. Supplier 26 is realized by, for example, a processor or the like.

Processor 41 decompresses a compressed audio signal and transmits the decompressed audio signal to converter 21 via second cable 60.

Third housing 40 is provided with connector 43. Connector 71 of cable 70 is connected to connector 43. An external device or the like is connected to cable 70 on the side opposite to the location of connector 71.

When the user listens to music stored in, for instance, a content server provided in a moving object, for example, the compressed audio signal of the music is transmitted from, for instance, an external device to processor 41 via cable 70. Processor 41 decompresses the received audio signal and transmits the decompressed audio signal to converter 21 via second cable 60. Converter 21 converts the received audio signal from a digital signal to an analog signal, and transmits the audio signal that has been converted to the analog signal to jack 31a (31b, 31c, 31d) via first cable 50. Here, the audio signal is amplified by amplifier 27 and then transmitted. Since a plug is inserted into jack 31a (31b, 31c, 31d), music is output from a device (e.g., earphones) including the plug and the user can listen to music using the device.

The necessity information is transmitted from, for instance, an external device to processor 41 via cable 70. Processor 41 transmits the received necessity information to supplier 26 via second cable 60. Supplier 26 determines necessity of power supply to jack 31a (31b, 31c, 31d) based on the necessity information, and supplies power to jack 31a (31b, 31c, 31d) via first cable 50 when it is determined that power supply is necessary.

As described above, in electronic device 10, first housing 20, second housing 30a (30b, 30c, 30d), and third housing 40 are different. Accordingly, it is possible to reduce the sizes of first housing 20, second housing 30a (30b, 30c, 30d), and third housing 40 compared to when jack 31a (31b, 31c, 31d), converter 21, processor 41 or the like are accommodated in a single housing. A space for providing these housings in a moving object is limited, but the housings are readily provided even in a limited space by reducing the sizes of the housings.

Moreover, the length of first cable 50 can be reduced by placing first housing 20 near second housing 30a (30b, 30c, 30d). By placing first housing 20 near third housing 40, the length of second cable 60 can be reduced.

When converter 21 breaks down, first housing 20 needs to be, for instance, taken out and repaired, and since second housing 30a (30b, 30c, 30d) and third housing 40 do not need to be taken out, the maintenance of the housings can be enhanced. Likewise, when jack 31a (31b, 31c, 31d) breaks down, second housing 30a (30b, 30c, 30d) needs to be, for instance, taken out and repaired, and first housing 20 and third housing 40 do not need to be taken out. When processor 41 breaks down, third housing 40 needs to be, for instance, taken out and repaired, and first housing 20 and second housing 30a (30b, 30c, 30d) do not need to be taken out. Thus, the maintenance of the housings can be enhanced.

Electronic device 10 according to the present embodiment is an electronic device to be provided inside a moving object, and includes: first housing 20 that accommodates converter 21 that converts an audio signal from a digital signal to an analog signal; and second housing 30a (30b, 30c, 30d) provided with jack 31a (31b, 31c, 31d) that outputs the audio signal that has been converted to the analog signal, where second housing 30a (30b, 30c, 30d) is different from first housing 20. First housing 20 is connected to second housing 30a (30b, 30c, 30d) via first cable 50.

According to this, since second housing 30a (30b, 30c, 30d) provided with jack 31a (31b, 31c, 31d) that outputs an audio signal is different from first housing 20 that accommodates converter 21, it is possible to inhibit an increase in the size of second housing 30a (30b, 30c, 30d) compared to when second housing 30a (30b, 30c, 30d) accommodates converter 21.

Moreover, in electronic device 10 according to the present embodiment, first housing 20 is provided at a first location that a user of electronic device 10 cannot directly touch, and jack 31a (31b, 31c, 31d) is provided at a second location that the user can directly touch.

According to this, it is possible to inhibit an increase in the size of jack 31a (31b, 31c, 31d) in a location that the user can directly touch.

Moreover, in electronic device 10 according to the present embodiment, the first location is the inside of seat 90 on which the user sits, and the second location is a location exposed to outside on seat 90.

According to this, it is possible to inhibit an increase in the size of jack 31a (31b, 31c, 31d) exposed in the vicinity of seat 90 of the user.

Moreover, electronic device 10 according to the present embodiment, further includes third housing 40 that accommodates processor 41 that decompresses the audio signal that has been compressed, where third housing 40 is different from first housing 20 and second housing 30a (30b, 30c, 30d). First housing 20 is connected to third housing 40 via second cable 60.

According to this, since third housing 40 that accommodates processor 41 is different from first housing 20 and second housing 30a (30b, 30c, 30d), it is possible to inhibit an increase in the size of first housing 20 or second housing 30a (30b, 30c, 30d) compared to when first housing 20 or second housing 30a (30b, 30c, 30d) accommodates processor 41.

Moreover, in electronic device 10 according to the present embodiment, the total number of cores of second cable 60 is less than the total number of cores of first cable 50.

According to this, it is easier to reduce the weight of the entire electronic device 10.

Moreover, in electronic device 10 according to the present embodiment, first connector 22 to which first cable 50 is to be connected and second connector 23 to which second cable 60 is to be connected are provided in first housing 20, and first connector 22 and second connector 23 have different shapes.

According to this, it is easier to use a suitable cable for each of first cable 50 and second cable 60.

Moreover, in electronic device 10 according to the present embodiment, first connector 22 and second connector 23 may face away from each other, and first housing 20 is formed such that the connection direction of first cable 50 toward first connector 22 is the lengthwise direction of first housing 20.

According to this, it is possible to inhibit an increase in the size of first housing 20 in a direction orthogonal to the connection direction of first cable 50 toward first connector 22.

Moreover, in electronic device 10 according to the present embodiment, first housing 20 is provided to obtain, via second cable 60, necessity information related to necessity of power supply to jack 31a (31b, 31c, 31d), determine the necessity based on the necessity information, and supply power via first cable 50 when it is determined that the power supply is necessary.

According to this, power can be supplied to jack 31a (31b, 31c, 31d) when power supply to jack 31a (31b, 31c, 31d) is necessary.

Moreover, in electronic device 10 according to the present embodiment, the second housing is configurable in a plurality of models (second housings 30a, 30b, 30c, and 30d), each including a different one of jacks 31a, 31b, 31c and 31d of different shapes.

According to this, it is possible to output an audio signal to a plurality of devices having plugs whose shapes are mutually different.

Moreover, in electronic device 10 according to the present embodiment, jacks 31a, 31b, 31c, and 31d include a jack compliant with an ARINC standard.

According to this, it is possible to output an audio signal to a device having a plug compliant with the ARINC standard.

### OTHER EMBODIMENTS, ETC.

Although an electronic device according to one or more aspects of the present disclosure has been described above based on an embodiment, the present disclosure is not limited to this embodiment. Other embodiments obtained by various modifications to the embodiment which may be conceived by those skilled in the art may be also included in the scope of the present disclosure so long as they do not depart from the essence of the present disclosure.

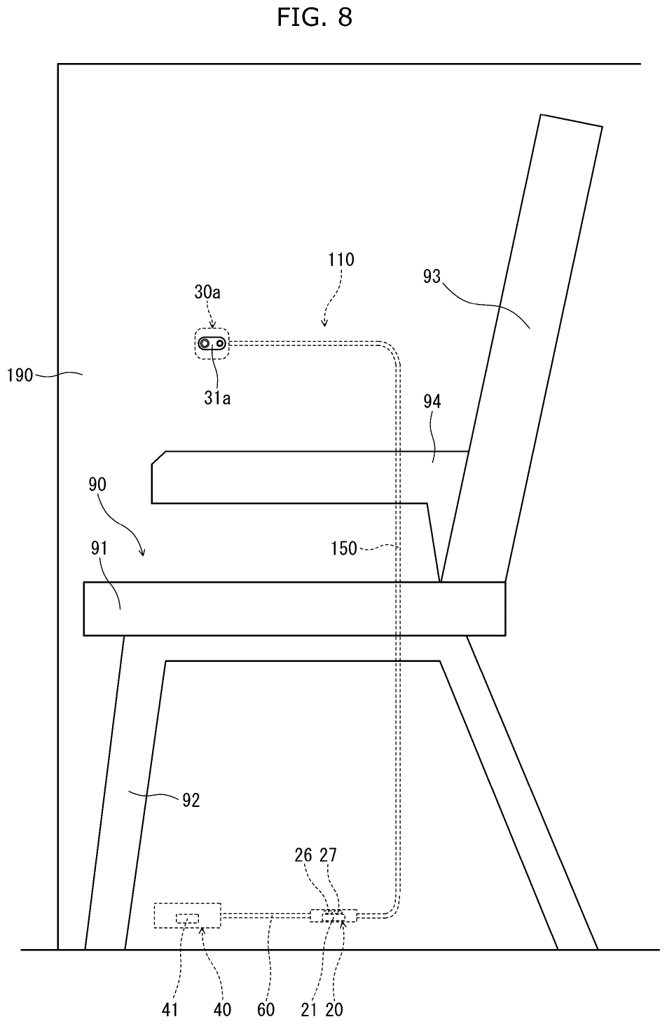

The aforementioned embodiment has illustrated a case where the first location is the inside of seat 90 and the second location is a location exposed to outside on seat 90, but the present disclosure is not limited to this case. FIG. 8 is a schematic diagram illustrating electronic device 110 and others according to other embodiment. Electronic device 110 includes first cable 150 instead of first cable 50, which is a main difference from electronic device 10. For example, jack 31a may be provided at a location that is exposed to outside on structure 190 in at least part of the vicinity of seat 90 on which the user sits, as illustrated in FIG. 8. First housing 20 and third housing 40 may be provided inside structure 190. Structure 190 is a wall placed at the lateral side of seat 90. Note that the structure may be, for example, a stand provided at the lateral side of seat 90, or a wall provided at the back of seat 90. A second housing to be connected to first cable 150 may be, instead of second housing 30a, second housing 30b, 30c, or 30d whose model is different from the model of second housing 30a. In this case, the jack in the second housing is provided at a location exposed to outside on structure 190. The first location may be, for example, the inside of a seat different from the seat on which the user sits (e.g., a seat in the vicinity of the seat on which the user sits). The second location may be a location exposed on a seat different from the seat on which the user sits (e.g., a seat in the vicinity of the seat on which the user sits). The seat in the vicinity of the seat on which the user sits is, for example, a seat adjacent to the seat on which the user sits, a seat in the front row of the seat on which the user sits, or a seat in the back row of the seat on which the user sits.

Although the aforementioned embodiment has illustrated a case where the second housing is configurable in a plurality of models, the present disclosure is not limited to this case. For example, the second housing may be configurable in only one type of model instead of a plurality of models.

### Supplementary Notes

The description of the above embodiments discloses the following techniques.

### (Technique 1)

An electronic device to be provided inside a moving object, the electronic device comprising:
a first housing that accommodates a converter that converts an audio signal from a digital signal to an analog signal; and
a second housing provided with a jack that outputs the audio signal that has been converted to the analog signal, the second housing being different from the first housing, wherein
the first housing is connected to the second housing via a first cable.

### (Technique 2)

The electronic device according to Technique 1, wherein
the first housing is provided at a first location that a user of the electronic device cannot directly touch, and
the jack is provided at a second location that the user can directly touch.

### (Technique 3)

The electronic device according to Technique 2, wherein
the first location includes an inside of a first seat on which the user sits, an inside of a second seat near the first seat, or an inside of a structure in a vicinity of the first seat, and
the second location includes a location exposed to outside on the first seat, a location exposed to outside on the second seat, or a location exposed to outside on the structure.

### (Technique 4)

The electronic device according to any one of Techniques 1 to 3, further comprising:
a third housing that accommodates a processor that decompresses the audio signal that has been compressed, the third housing being different from the first housing and the second housing, wherein
the first housing is connected to the third housing via a second cable.

### (Technique 5)

The electronic device according to Technique 4, wherein
a total number of cores of the second cable is less than a total number of cores of the first cable.

### (Technique 6)

The electronic device according to Technique 4 or 5, wherein
a first connector to which the first cable is to be connected and a second connector to which the second cable is to be connected are provided in the first housing, and
the first connector and the second connector have different shapes.

### (Technique 7)

The electronic device according to Technique 6, wherein
the first connector and the second connector face away from each other, and
the first housing is formed such that a connection direction of the first cable toward the first connector is a lengthwise direction of the first housing.

### (Technique 8)

The electronic device according to any one of Techniques 4 to 7, wherein
the first housing is provided to obtain, via the second cable, necessity information related to necessity of power supply to the jack, determine the necessity based on the necessity information, and supply power via the first cable when it is determined that the power supply is necessary.

### (Technique 9)

The electronic device according to any one of Techniques 1 to 8, wherein
the second housing is configurable in a plurality of models, each including the jack of a different shape, each of the jacks being the jack.

### (Technique 10)

The electronic device according to Technique 9, wherein
the jacks include a jack compliant with an ARINC standard.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure can be used for an electronic device that is provided inside a moving object and converts an audio signal from a digital signal to an analog signal to output the audio signal.

1. An electronic device to be provided inside a moving object, the electronic device comprising:
a first housing that accommodates a converter that converts an audio signal from a digital signal to an analog signal; and
a second housing provided with a jack that outputs the audio signal that has been converted to the analog signal, the second housing being different from the first housing, wherein
the first housing is connected to the second housing via a first cable.

2. The electronic device according to claim 1, wherein
the first housing is provided at a first location that a user of the electronic device cannot directly touch, and
the jack is provided at a second location that the user can directly touch.

3. The electronic device according to claim 2, wherein
the first location includes an inside of a first seat on which the user sits, an inside of a second seat near the first seat, or an inside of a structure in a vicinity of the first seat, and
the second location includes a location exposed to outside on the first seat, a location exposed to outside on the second seat, or a location exposed to outside on the structure.

4. The electronic device according to claim 1, further comprising:
a third housing that accommodates a processor that decompresses the audio signal that has been compressed, the third housing being different from the first housing and the second housing, wherein
the first housing is connected to the third housing via a second cable.

5. The electronic device according to claim 4, wherein
a total number of cores of the second cable is less than a total number of cores of the first cable.

6. The electronic device according to claim 4, wherein
a first connector to which the first cable is to be connected and a second connector to which the second cable is to be connected are provided in the first housing, and
the first connector and the second connector have different shapes.

7. The electronic device according to claim 6, wherein
the first connector and the second connector face away from each other, and
the first housing is formed such that a connection direction of the first cable toward the first connector is a lengthwise direction of the first housing.

8. The electronic device according to claim 4, wherein
the first housing is provided to obtain, via the second cable, necessity information related to necessity of power supply to the jack, determine the necessity based on the necessity information, and supply power via the first cable when it is determined that the power supply is necessary.

9. The electronic device according to claim 1, wherein
the second housing is configurable in a plurality of models, each including the jack of a different shape, each of the jacks being the jack.

10. The electronic device according to claim 9, wherein
the jacks include a jack compliant with an ARINC standard.
